(19) United States
(12) Patent Application Publication
(10) Pub. No.: US 2024/0396644 A1
(43) Pub. Date: Nov. 28, 2024

(54) SYSTEMS FOR OBFUSCATING SIGNALS AND RELATED METHODS AND NON-TRANSITORY COMPUTER-READABLE MEDIA

(71) Applicant: Battelle Energy Alliance, LLC, Idaho Falls, ID (US)

(72) Inventors: Brian J. LeNeave, Idaho Falls, ID (US); James A. Smith, Idaho Falls, ID (US)

(21) Appl. No.: 18/672,932

(22) Filed: May 23, 2024

Related U.S. Application Data
(60) Provisional application No. 63/503,906, filed on May 23, 2023.

(51) Int. Cl. H04B 17/20

(52) U.S. Cl. CPC H04B 17/201

(57) ABSTRACT

A system may comprise a sensor, a transmitter, and a receiver where the transmitter and receiver are remote from the sensor. The receiver may include a processor and instructions to receive a signal comprising a plurality of subcarriers and including first radio waves and second radio waves, determine a signal to noise ratio of each of the subcarriers, and extract the first radio waves from the signal responsive to the signal to noise ratio of each of the subcarriers. Methods and non-transitory computer-readable media are also disclosed.

### CROSS-REFERENCE TO RELATED APPLICATION

This application claims the benefit under 35 U.S.C. § 119 (e) of U.S. Provisional Patent Application Ser. No. 63/503,906, filed May 23, 2023, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

Embodiments of the disclosure relate generally to obfuscating or masking signals.

### BACKGROUND

Radio Frequency (RF) sensors may be used to sense and transmit information. RF sensors emit electromagnetic waves at a specific frequency into a surrounding environment. RF sensors typically also include a receiver that captures RF waves after they have interacted with an environment. For example, the receiver may detect changes in signal strength, phase, frequency or other characteristics. In some cases, an RF sensor may receive an exciter signal from a source exciter, then modify the signal based on environmental conditions surrounding the RF sensor. The RF sensor may then transmit the modified signal where the modified signal may include indications of the environmental conditions sensed by the RF sensor.

### BRIEF SUMMARY

Some embodiments of the disclosure may include a system. The system may include a sensor configured to transmit first radio waves, a transmitter remote from the sensor and configured to transmit second radio waves, the second radio waves carrying null data, a receiver remote from the sensor and configured to receive the first radio waves and the second radio waves. The receiver may include a processor and a non-transitory computer-readable medium storing instructions thereon, the instructions configured to cause the processor to: receive a signal waveform comprising a plurality of subcarriers, the signal waveform including the first radio waves and the second radio waves; determine a signal to noise ratio of each subcarrier of the plurality of subcarriers; and extract the first radio waves from the signal waveform responsive to the determined signal to noise ratio of each subcarrier of the plurality of subcarriers.

Further embodiments of the disclosure may include a method. The method may include receiving a signal wave form comprising a plurality of subcarriers, the signal waveform including first radio waves and second radio waves, determining a signal to noise ratio of each subcarrier of the plurality of subcarriers, and extracting the first radio waves from the signal waveform responsive to the determined signal to noise ratio of each subcarrier of the plurality of subcarriers.

Further embodiments of the disclosure may include a non-transitory computer-readable medium storing instructions thereon. The instructions may cause a processor to receive a signal waveform comprising a plurality of subcarriers, the signal waveform including the first radio waves and the second radio waves, determine a signal to noise ratio of each subcarrier of the plurality of subcarriers, and extract the first radio waves from the signal waveform responsive to the determined signal to noise ratio of each subcarrier of the plurality of subcarriers.

### BRIEF DESCRIPTION OF THE SEVERAL VIEWS OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 shows a schematic diagram of an RF sensor system according to one or more embodiments of the disclosure;

FIG. 2 illustrates a RF masking system according to one or more embodiments of the disclosure;

FIG. 3 is a flowchart illustrating a method according to one or more embodiments of the disclosure;

FIG. 4 shows an example waveform of a signal and a plurality of subcarriers included in the waveform as well as a signal to noise ratio for each of the subcarriers of the plurality of subcarriers according to one or more embodiments of the disclosure;

FIG. 5 shows a waveform of a signal and a plurality of subcarriers included in the wave form as well as a signal to noise ratio for each of the sub carriers of the plurality of subcarriers according to one or more embodiments of the disclosure;

FIG. 6 is a schematic diagram of an example RFID sensor according to one or more embodiments of the disclosure.

FIG. 7 is a graph 700 illustrating an analog signal emitted by an RFID sensor according to embodiments of the disclosure. Specifically, the graph 700 illustrates the signal as a function of power (dBm) over frequency (MHz) according to one or more embodiments of the disclosure;

FIG. 8 is a graph illustrating an analog signal emitted by an RFID sensor according to embodiments of the disclosure;

FIG. 9 is a block diagram of circuitry that, in some examples, may be used to implement various functions, operations, acts, processes, and/or methods disclosed herein.

### DETAILED DESCRIPTION

Radio frequency (RF) tags (e.g., RF sensors) are utilized across various fields for a multitude of purposes due to their ability to detect, monitor, and analyze electromagnetic signals within the radio frequency spectrum. RF sensors may be used to detect environmental conditions for environments that are difficult to measure because of the inherent danger of those environments. For example, processes of a nuclear power plant may be difficult or impossible to measure directly because of the heat, pressure, or radiation of the environment in which the processes of the nuclear plant are conducted. Wired sensors are commonly used in critical infrastructure having these extreme environments. However, using wireless sensors may greatly reduce common points of failure and security risks caused by wires and their connections. Furthermore, wireless sensors have lower costs for installation and maintenance and may also have increased reliability by not routing wires and removing physical connections. Furthermore, wireless RF sensors may be placed within harsh or inhospitable environments and may measure various aspects of the environment and communicate these measurements to a remote receiver via one or more radio waves. For example, a source exciter may transmit a radio frequency or signal where an RF sensor disposed within an inhospitable chamber of a nuclear plant may receive the transmitted radio frequency or signal transmitted by the source exciter. The RF sensor may then modify the exciter signal based on the environment proximate to the RF sensor (e.g., heat, pressure, strain, etc.) and broadcast the modified signal. The broadcasted signal may then be received by a receiver that may be remote (e.g., physically remote from the RF sensor or an environment in which the RF sensor is located) from the RF sensor. The modified signal carries information pertaining to the environment proximate the RF sensor (e.g., heat, pressure, strain, without limitation). However, the receiver configured to receive the modified signal may be vulnerable to cyber security attacks from possible “jammers” or “spoofers” or “interceptors.” For example, in a jamming attack, a hostile actor may attempt to interfere with the reception of the modified signal broadcast from the RF sensor. This attack may be designed to disrupt or degrade the modified signal. Further, in a spoofing attack, a hostile actor may broadcast their own signal to the receiver such that the receiver thinks that the broadcast from the hostile actor is the signal broadcast by the RF sensor. These attacks may cause faulty sensor data which may cause the process measured by the RF sensor to become unstable. For example, a system relying on information from the RF sensor to make adjustments or changes to run a process safely may be unable to do so if these attacks are perpetrated. The damage caused as a result of the processes of critical infrastructure (e.g., a nuclear plant) that are interfered with may be catastrophic and costly.

Accordingly, embodiments of the disclosure may include a system (e.g., an RF signal masking system) that masks a signal propagated (e.g., broadcast) from a tag or sensor (e.g., an RF sensor) using a transmitter (e.g., a wide-band transmitter) transmitting a masking wide-band transmitter signal and a receiver (e.g., a wide-band communication receiver) to extract an RF sensor signal from the masking wide-band transmitter signal to prevent interference with the signal broadcast from the RF tag or sensor by a third party. In some embodiments the system may include a sensor configured to transmit first radio waves, a wide-band communication transmitter remote from the sensor that is configured to transmit second radio waves, and a wide-band communication receiver remote from the sensor that is configured to receive the first radio waves and the second radio waves. The second radio waves may be configured to mask or obfuscate the first radio waves when received by the receiver. For example, the spectral power of the second radio waves may be larger than that of the first radio waves such that the second radio waves create a noise floor that hides or obfuscates the first radio waves. In some embodiments, the RF signal masking system may receive a signal waveform comprising a plurality of subcarriers, where the signal waveform includes the first and the second radio waves. The RF signal masking system may determine a signal to noise ratio of each subcarrier of the plurality of subcarriers and extract the first radio waves from the signal waveform responsive to the determined signal to noise ratio of each subcarrier of the plurality of subcarriers. By masking the first radio waves, the signal broadcast from the sensor may be protected from outside interference such as jamming or spoofing or intercepting attacks to ensure secure, accurate and uninterrupted process of an infrastructure system, such as a nuclear reactor. Though discussed in particular contexts (e.g., critical infrastructure such as a nuclear power plant), the RF signal masking system according to embodiments of the disclosure may be used in any infrastructure where it is desirable to prevent hostile actors from eavesdropping on tag or sensor communication and/or spoofing sensor signals. For example, the RF signal masking system may be implemented in a smart city (e.g., cities including traffic management systems, smart energy grids, public Wi-Fi networks, real-time air quality monitoring, package delivery tracking, parts inventory and identification etc.), smart buildings as well as critical, industrial, and structural infrastructures.

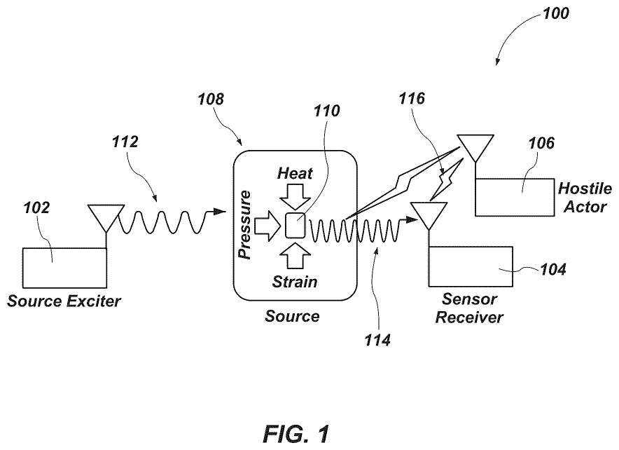

FIG. 1 shows a schematic diagram of a conventional RF sensor (e.g., RFID sensor) system 100 illustrating hostile actor interference. The system 100 may include a Radio Frequency (RF) sensor exciter 102, a RF sensor (i.e., a source) receiver 104, and a hostile actor 106. RF sensor 110 may be located in an environment 108. As a non-limiting example, the environment 108 may represent the inside of a nuclear reactor or any other location that may have conditions that are impractical or impossible for a person to inhabit. The source RF sensor exciter 102, sensor receiver 104, and the hostile actor 106 may all be located remote from the RF sensor 110. The RF sensor exciter 102 may be configured to generate an exciter signal 112 and communicate the exciter signal 112 to the RF sensor 110. The exciter signal 112 may be in the form of a plurality of electromagnetic waves configured to induce electrical currents in the RF sensor 110. The RF sensor 110 may include one or more sensor elements configured to measure characteristics (e.g., properties) of the environment 108 including heat, pressure, or strain, without limitation. After the exciter signal 112 is received at the RF sensor 110, the RF sensor 110 may emit a modulated signal 114 (e.g., based, at least in part, on the exciter signal) indicative of the data measured by the RF sensor 110 (e.g., characteristics of the environment 108). The RF sensor 110 may encode the data with a unique identifier associated with the RF sensor 110 and broadcast the modulated signal 114 to be received at a receiver, such as the sensor receiver 104. The sensor receiver 104 may then process the modulated signal 114 to decode the signal and extract information pertaining to the RF sensor 110 and data indicative of characteristics of the environment 108. However, because the modulated signal 114 is generally broadcast, a hostile actor, such as hostile actor 106, may receive the modulated signal 114 and spoof (e.g., send a different signal using the unique identifier transmitted in the modulated signal 114) the modulated signal 114 to generate a spoofed signal 116 and send the spoofed signal 116 to the sensor receiver 104. Because the spoofed signal 116 transmitted by the hostile actor 106 may use the unique identifier associated with the RF sensor 110, the sensor receiver 104 may not be able to tell that the spoofed signal 116 is not the signal transmitted by the RF sensor 110. Accordingly, the hostile actor 106 may convey false or misleading information to the sensor receiver 104 via the spoofed signal 116 to interfere with processes executed within the environment 108. For example, by giving false information, the hostile actor 106 may cause inaccurate data to be received at the sensor receiver 104 such that an operator of a process within the environment 108 may change one or more operating parameters of the process based on the false information. Similarly, automated processes based on measurements of the environment 108 may, based on the false information, become unstable, which may lead to disruptions or failure of the process within the environment 108. The hostile actor 106 may also attempt to jam or otherwise intercept the modulated signal 114 to prevent the sensor receiver 104 from being able to detect the modulated signal 114 or to view the data contained within the modulated signal 114. In some examples where the process involves generating power via a nuclear reactor, disruption of the processes of the nuclear reactor may lead to catastrophic consequences.

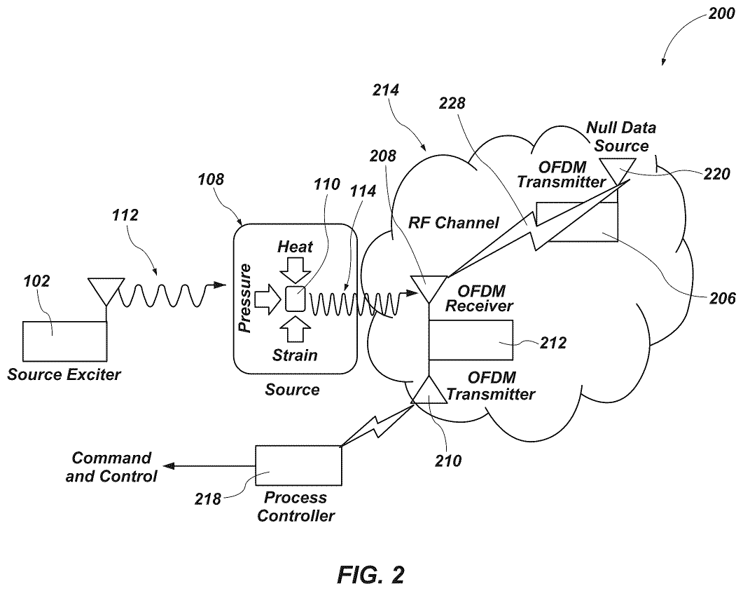

FIG. 2 illustrates a RF masking system 200 according to one or more embodiments of the disclosure. The RF masking system 200 may include the RF sensor exciter 102, the environment 108, and the RF sensor 110 of FIG. 1. The RF sensor may be in the form of an RFID tag (e.g., passive, active, semi-passive, ultra-high frequency, low frequency, high frequency, or NFC tag). The RF masking system 200 may also include a transceiver 212, a null data transmitter 206, and a process controller 218. The transceiver 212 may include a wide-band communication receiver and a transmitter 210. The null data transmitter 206 may include a null data source 220 in the form of a transmitter configured to transmit one or more radio or electromagnetic waves (e.g., null data signal 228) containing null data. The transceiver 212 and the null data transmitter 206 may be placed proximate to each other and may each be remote from the RF sensor 110.

The null data signal 228 transmitted by the null data transmitter 206 may be configured to “cloak” or “mask” a signal received by the receiver 208 via the RF sensor 110. For example, when the source RF sensor exciter 102 transmits the exciter signal 112 to the RF sensor 110 and the subsequent modulated signal 114 is broadcast from the RF sensor 110, the null data transmitter 206 may, via the null data source 220, continuously transmit a masking signal (e.g., null data) that may be received by the receiver 208 of the transceiver 212. The masking signal may generate a null data mask 214 over an area defined by a range of the null data transmitter 206. The null data signal 228 may be in the form of a signal that does not contain any meaningful information or data. For example, the null data of the null data signal 228 may be representative of all binary 0's or all binary 1's or a random or pseudorandom or intelligent (such as false sensor signals) pattern of 1's and 0's. An RF channel of the receiver 208 may receive a signal waveform that includes the modulated signal 114 emitted by the RF sensor 110, the null data signal 228 transmitted by the null data transmitter 206, and noise present in the receiving environment. In some embodiments, the signal waveform may operate above a thermal or electrical noise floor.

At the receiver 208, the RF spectrum of the null data signal 228 may be spectrally larger in amplitude than a wave form of the modulated signal 114 transmitted by the RF sensor 110. In this way, the null data signal 228 creates a noise floor that is spectrally larger than the modulated signal 114. As a result, the waveform of the modulated signal 114 from the RF sensor 110 may be hidden (e.g., masked or obfuscated) by the waveform of the null data signal 228 transmitted by the null data transmitter 206. Accordingly, a hostile actor (e.g., hostile actor 106) or any other third party would not be able to “see” or sense the modulated signal 114 from the RF sensor 110 but would only be able to see the null data signal 228 emitted by the null data transmitter 206. In order to detect the modulated signal 114, the receiver 208 of the transceiver 212 may use embedded signal processing circuitry to extract the exact location and frequency of the modulated signal 114 that is underneath the null data signal 228 waveform. For example, the transceiver 212 may include one or more processors for analyzing a signal waveform. In some embodiments, the embedded signal processing circuitry may be configured to extract signals emitted from particular RFID devices (e.g., RF sensor 110).

In some embodiments, the modulated signal 114 may be extracted by analyzing a signal to noise ratio of each subcarrier of a signal waveform (e.g., the waveform including the modulated signal 114, the null data signal 228, and environment noise) to identify a subcarrier that is carrying the modulated signal 114. The modulated signal 114 may then be extracted responsive to a comparison between the signal waveform on the identified subcarrier and an expected or predetermined waveform (null signal). For example, the desired modulated signal 114 can be extracted by determining a deviation in the expected signal to noise ratio of the null signal in a subcarrier channel. Using this technique, the modulated signal 114 may be identified as originating from the RF sensor 110.

The extracted modulated signal 114 may then be sent, via the transmitter 210 of the transceiver 212 to the process controller 218 for further processing. For example, the process controller 218 may extract the one or more characteristics of the environment 108 from the modulated signal 114 and pass the extracted data on to another entity, such as command and control systems. In some embodiments, the modulated signal 114 may be a plurality of modulated signals emitted from a single sensor or from a plurality of sensors where each modulated signal may be spaced far enough apart in frequency (e.g., in different subcarriers) so as to not interfere with each other.

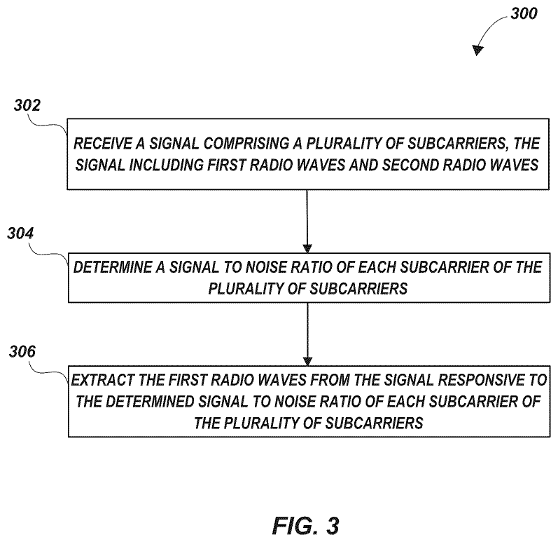

FIG. 3 is a flowchart 300 illustrating an operation of the RF masking system 200 according to one or more examples of the disclosure. For instance, FIG. 3 shows one or more embodiments of a simplified sequence-flow that the RF masking system 200 may use to obfuscate one or more signals emitted by an RF sensor(s) (e.g., RF sensor 110). As used herein, “mask,” “cloak,” or “obfuscate” when used in reference to signals may refer to the act of making a signal harder to detect or harder to discern from other signals or noise in an environment.

At operation 302 the RF masking system 200 receives, via the receiver 208 of the transceiver 212, a signal waveform comprising a plurality of subcarriers, the signal including first radio waves and second radio waves. For example, the signal waveform may be in the form of subcarriers that span a frequency range. A subcarrier may be the result of the superposition of the first radio waves and the second radio waves. As a specific example, a subcarrier may be the result of performing orthogonal frequency division multiplexing (OFDM) on the null signal to divide the null signal into multiple orthogonal subcarriers, each subcarrier occupying a specific frequency within the overall bandwidth of the carrier signal (e.g., a null signal). However, any conventional method of dividing a carrier signal into multiple subcarriers may be used. For example, a waveform that uses filter bank multi-carrier as a modulation scheme may be used to promote isolation between subcarriers. With more isolation, there is higher resolution of where an incumbent signal interferers with the subcarriers. This may increase the ability of the system to extract information from the signal emitted by an RF sensor. The first radio waves may include a signal emitted by an RF sensor (e.g., modulated signal 114) and the second radio waves may include a null signal (e.g., null data signal 228). The signal may also include noise present in the receiving environment. In some embodiments, the second radio waves may be spectrally larger than the first radio waves. For example, the second radio waves may cover a wider bandwidth (e.g., a wider range of frequencies) than the first radio waves such that a bandwidth of the first radio waves are a subset of the bandwidth of the second radio waves. Furthermore, the second radio waves may have a greater power (e.g., amplitude) than the first radio waves. Accordingly, to a third party, the first radio waves will be at least substantially hidden or obfuscated by the second radio waves. In some embodiments, the first radio waves may inhabit the same subcarrier frequency range as generated by the null signal of the received signal waveform.

At operation 304, the RF masking system 200 determines a signal to noise ratio of each subcarrier of the plurality of subcarriers. For example, the transceiver 212 may include signal processing circuitry configured to analyze a signal waveform. The signal processing circuitry may analyze each subcarrier of the signal waveform received at the transceiver 212. For example, the signal processing circuitry may analyze a signal to noise ratio of each subcarrier. The signal to noise ratio of a subcarrier may indicate a ratio of a detected signal and detected noise within the subcarrier.

At operation 306, the RF masking system 200 extracts the first radio waves from the signal waveform responsive to the determined signal to noise ratio of each subcarrier. For example, the signal processing circuitry of the transceiver 212 may be configured to determine a signal (e.g., modulated signal 114) at one or more of the analyzed subcarriers. In some embodiments, the transceiver 212 may be configured to detect signal known to be associated with the RF sensor 110. After identification of a signal component, the signal processing circuitry may be configured to measure the strength of the detected signal component (e.g., measuring amplitude, power, etc.). The signal processing circuitry may also be configured to determine a level of noise present in the signal. For example, the signal processing circuitry may detect a level of noise (e.g., measuring amplitude, power, etc.) present in the signal. In some embodiments, the signal processing circuitry may be configured to determine a portion of a subcarrier belonging to the null data signal 228 as well as noise present in the operating environment of the RF masking system 200 and determine a power of the null data signal and the noise present in the operating environment of the RF masking system 200 combined. The signal processing circuitry may then calculate a signal to noise ratio (SNR). For example, a signal to noise ratio may be calculated using the formula:

$$SNR = \frac{signal power}{noise power}$$

where a relatively higher SNR may indicate a stronger signal relative to noise and a relatively lower SNR may suggest that noise is more prevalent than a detected signal. If the SNR is higher (or lower as the case may be if comparing noise power over signal power) than other calculated SNRs of other subcarriers or if the SNR deviates from a pre-determined or expected SNR or if the SNR exceeds a pre-determined threshold (e.g., is above or below a pre-determined threshold), the signal processing circuitry may determine that a signal (e.g., an RFID sensor signal such as modulated signal 114) is present in the subcarrier being analyzed. The signal processing circuitry may then extract the detected signal responsive to the calculated SNR. For example, the signal processing circuitry may receive the entirety of the signal detected on the subcarrier identified as containing the signal based on the SNR of the subcarrier and perform one or more operations on the signal (e.g., transformations, etc.). The signal processing circuitry may also provide the extracted signal to other processing structures (e.g., process controller 218) to perform one or more operations on the signal or provide the signal to other entities.

Though discussed in terms of obfuscating sensor signals when the sensor is placed into an inhospitable environment, a person of ordinary skill in the art will appreciate that the disclosure is not so limited. For example, the RF masking system 200 may be used to obfuscate signals from any RFID tag. For example, the RF masking system may be used to obfuscate RFID tags located in parts, packages or buildings or in any other type of environment.

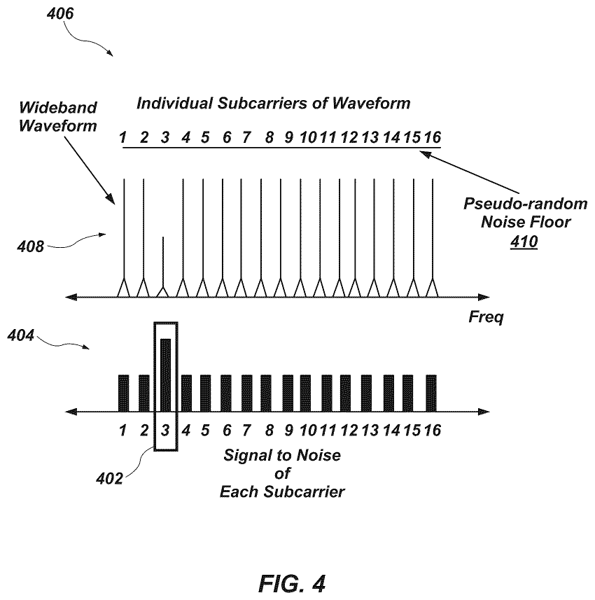

FIG. 4 shows an example waveform 406 of a signal waveform and a plurality of subcarriers 408 included in the waveform as well as a chart 404 illustrating a signal to noise ratio for each of the subcarriers 408. For example, a receiver (e.g., the RFID receiver 208 of the transceiver 212) may receive the waveform 406 where a signal (e.g., modulated signal 114) may be present within a subcarrier of the waveform 406. For example, referring to FIG. 2, the modulated signal 114 may interfere with one or more subcarriers generated by the null signal of the waveform 406. In this particular example, the modulated signal 114, is interfering less with subcarrier 3 than the others of subcarriers 408. The signal processing circuitry included in the transceiver 212 may process the waveform 406 to determine a SNR of each subcarrier. It may then be determined which subcarrier of the subcarriers 408 is being least interfered with based on the determined SNR of each subcarrier. The measured environmental data associated with the process (e.g., the modulated signal 114 emitted by the RF sensor) may then be determined responsive to extracting the modulated signal 114 that is interfering with subcarrier 3 (indicated by box 402). The extracted data may then be backhauled (e.g., transmitted or otherwise transferred) to a remote location (e.g., a location physically remote from the RF sensor and the transceiver 212) for further analysis. For example, the extracted data may be transmitted to a command and control server for further processing.

As shown in the waveform 406 below a pseudo-random noise floor 410 and chart 404, a minimal incumbent sinusoid (the modulated signal 114 transmitted from the RF sensor 110) is located at the third subcarrier frequency of the wide band waveform. The signal processing circuitry of the transceiver 212 calculates a SNR metric of each subcarrier, and the third subcarrier shows a higher signal to noise ratio compared to the other subcarriers. In this manner, the operating frequency of the RF sensor 110 may be extracted. With the sensitivity curves and the measured operating frequency of the sensor, the measurements, such as temperature, pressure and strain, may be extracted. This detection of the incumbent signal may happen while the wide-band radios (e.g., the transceiver 212 of FIG. 2) are still performing their primary objective of securing two-way communication to command and data centers.

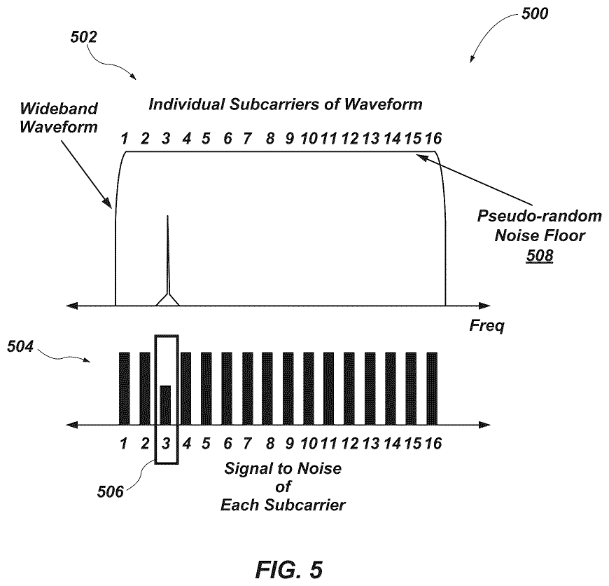

FIG. 5 shows an example waveform 500 of a signal below a pseudo-random noise floor 508 and a plurality of subcarriers included in the waveform as well as a signal to noise ratio for each of the subcarriers of the plurality of subcarriers. For example, the receiver may receive the waveform 500 where underneath the waveform, there is the incumbent signal at a particular frequency. This signal may begin to interfere with one of the subcarriers of the waveform 500. In this particular example, the sensor signal is interfering with subcarrier 3. In the signal processing of the waveform 502, the signal to noise ratio of each subcarrier may be determined, as shown in graph 504. It may then be determined which subchannel is being interfered with based on an analysis of the signal to noise ratio of each subcarrier. The measured environmental data of the process (e.g., the signal emitted by the RF sensor) may then be determined responsive to extracting the waveform interfering with subcarrier 3 (indicated by box 506). Existing radios (e.g., radio transmitters or transceivers) may then be used to backhaul that data to a remote location for further analysis.

For example, as illustrated in FIG. 5, an incumbent sinusoid (sensor signal) is located at the third subcarrier frequency of the wide band waveform 500. The receiver calculates a SNR metric of each subcarrier, and the third subcarrier shows a reduced signal to noise ratio compared to the other subcarriers. The waveform 500 may then identify the incumbent signal as being at the same frequency as the third subcarrier. In this manner, the operating frequency of the frequency modulated sensor can be extracted. With the sensitivity curves and the measured operating frequency of the sensor, the measurand, such as temperature, pressure and strain, can be extracted. This detection of the incumbent signal may be occurring while the wide-band radios (e.g., the transmitter and receiver of FIG. 1) are still performing their primary objective of securing two-way communication to command and data centers.

Referring to FIGS. 2-5, by using the null data signal 228 to obfuscate the modulated signal 114, the data contained within the modulated signal 114 may be effectively hidden from a hostile third-party actor such that the third-party actor's attempts to spoof or jam or intercept the modulated signal 114 may be frustrated. By using this technique, various processes of critical infrastructure such as nuclear reactors or other infrastructure including smart cities, smart buildings, smart energy grids, public Wi-Fi networks, real-time air quality monitoring, or NFC tags may be protected from third party spoofing or jamming attacks.

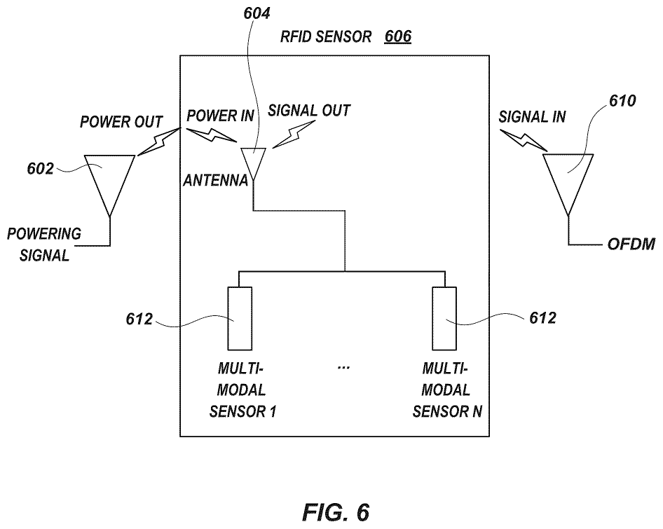

FIG. 6 is a schematic diagram of an example RF sensor 606 according to one or more embodiments of the disclosure. For example, the RF sensor may include an antenna 604, and one or more multi-modal sensors 612. The antenna 604 may be configured to send and receive one or more signals. For example, a power signal (i.e., an exciter signal) transmitted by a transmitter 602 may be received at the antenna 604 to provide power to the RF sensor 606. For example, upon being powered, the receiver 610 may receive one or more measurement metrics from multi-modal sensors 612. The multi-modal sensors 1−N 612 may be configured to measure one or more characteristics of an environment (e.g., environment 108). For example, the multi-modal sensors 612 may be configured to measure one or more characteristics including temperature, pressure, and strain, without limitation. The measurements may be received by the receiver 610 and containing information indicative of measurements of the multi-modal sensors 612. A receiver 610 may then receive the modulated signal for processing to verify the unique identifier of the RF sensor 606 and to extract the information indicative of measurements of the multi-modal sensors 612.

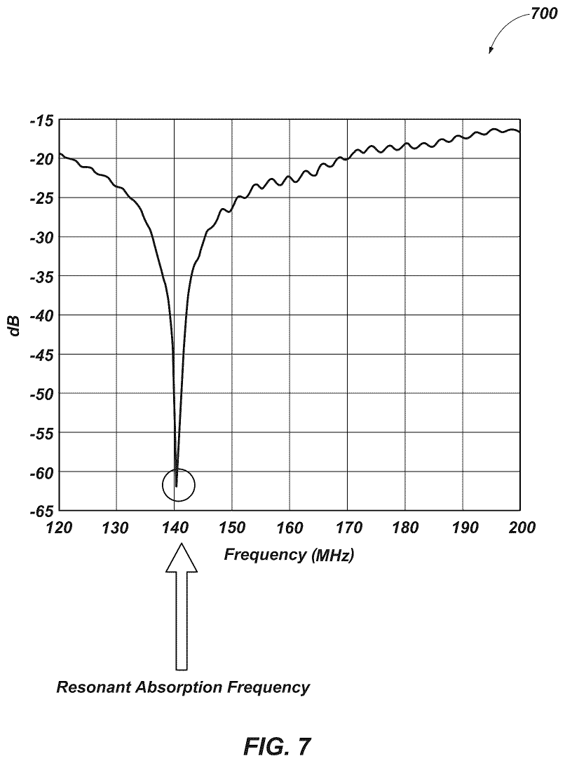

FIG. 7 is a graph 700 illustrating a resonant absorption frequency of an RFID tag (e.g., RF sensor 110). Specifically, the graph 700 illustrates the signal as a function of power (dBm) over frequency (MHz). Furthermore, FIG. 7 illustrates the resonant absorption frequency at 130 MHz carrier frequency where the signal represents a back-reflected signal from the RF sensor (e.g., the modulated signal 114 detected by the receiver 208 of the transceiver 212). The back-reflected signal may include sensor data including temperature, humidity, pressure, or other parameters of an environment (e.g., environment 108). The resonant absorption frequency may represent a frequency at which the RFID tag's (e.g., RF sensor 110) antenna efficiently absorbs energy from the exciter signal 112.

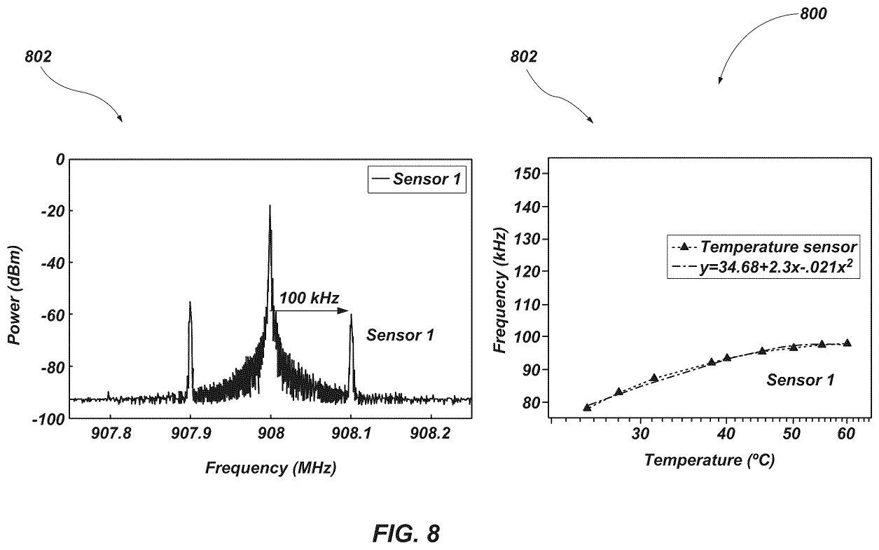

FIG. 8 shows graphs 800 illustrating an analog signal emitted by the RF sensor. Specifically, the graph 802 illustrates the signal as a function of power (dBm) over frequency (MHz). Graph 802 shows sensor data modulation of 100 kHz at 908 MHz carrier frequency. The signal shown in graph 802 may represent an emitted signal from the RF sensor with a temperature measurement. Furthermore, graph 804 may illustrate a measurement captured at a sensor (e.g., shown in the graph to be a sensor labeled “sensor 1”) resonant frequency shift in kHz versus temperature.

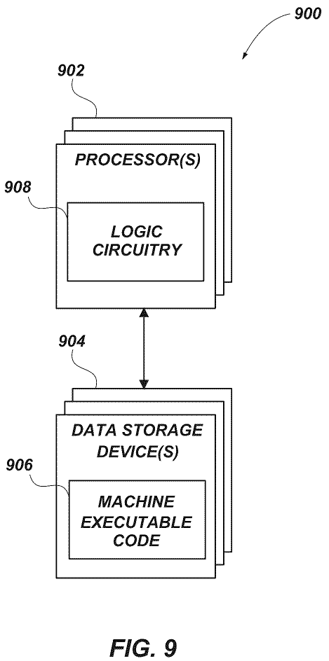

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 9 illustrates non-limiting examples of implementations of functional elements disclosed herein. In some examples, some or all portions of the functional elements disclosed herein may be performed by hardware specially configured for carrying out the functional elements.

FIG. 9 is a block diagram of circuitry 900 that, in some examples, may be used to implement various functions, operations, acts, processes, and/or methods disclosed herein. The circuitry 900 includes one or more processors 902 (sometimes referred to herein as “processors 902”) operably coupled to one or more data storage devices (sometimes referred to herein as “storage 904”). The storage includes machine executable code 906 stored thereon and the processors 902 include logic circuitry 908. The machine executable code 906 includes information describing functional elements that may be implemented by (e.g., performed by) the logic circuitry 908. The logic circuitry 908 is adapted to implement (e.g., perform) the functional elements described by the machine executable code 906. The circuitry 900, when executing the functional elements described by the machine executable code 906, should be considered as special purpose hardware configured for carrying out functional elements disclosed herein. In some examples the processors 902 may perform the functional elements described by the machine executable code 906 sequentially, concurrently (e.g., on one or more different hardware platforms), or in one or more parallel process streams.

When implemented by logic circuitry 908 of the processors 902, the machine executable code 906 is to adapt the processors 902 to perform operations of examples disclosed herein. For example, the machine executable code 906 may adapt the processors 902 to perform at least a portion or a totality of the operation 300 of FIG. 3. As a specific, non-limiting example, the machine executable code 906 may adapt the processors 902 to extract a signal based on the signal to noise ratio of each of a plurality of subcarriers.

The processors 902 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine executable code 906 (e.g., software code, firmware code, hardware descriptions) related to examples of the disclosure. It is noted that a general-purpose processor (may also be referred to herein as a host processor or simply a host) may be a microprocessor, but in the alternative, the processors 902 may include any conventional processor, controller, microcontroller, or state machine. The processors 902 may also be implemented as a combination of computing devices, such as a combination of a DSP and a microprocessor, a plurality of microprocessors, one or more microprocessors in conjunction with a DSP core, or any other such configuration.

In some examples the storage 904 includes volatile data storage (e.g., random-access memory (RAM)), non-volatile data storage (e.g., Flash memory, a hard disc drive, a solid state drive, erasable programmable read-only memory (EPROM), etc.). In some examples the processors 902 and the storage 904 may be implemented into a single device (e.g., a semiconductor device product, a system on chip (SOC), etc.). In some examples the processors 902 and the storage 904 may be implemented into separate devices.

In some examples the machine executable code 906 may include computer-readable instructions (e.g., software code, firmware code). By way of non-limiting example, the computer-readable instructions may be stored by the storage 904, accessed directly by the processors 902, and executed by the processors 902 using at least the logic circuitry 908. Also by way of non-limiting example, the computer-readable instructions may be stored on the storage 904, transferred to a memory device (not shown) for execution, and executed by the processors 902 using at least the logic circuitry 908. Accordingly, in some examples the logic circuitry 908 includes electrically configurable logic circuitry 908.

In some examples the machine executable code 906 may describe hardware (e.g., circuitry) to be implemented in the logic circuitry 908 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large scale integration (VLSI) hardware description language (VHDL™) may be used.

HDL descriptions may be converted into descriptions at any of numerous other levels of abstraction as desired. As a non-limiting example, a high-level description may be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 908 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine executable code 906 may include an HDL, an RTL, a GL description, a mask level description, other hardware description, or any combination thereof.

In examples where the machine executable code 906 includes a hardware description (at any level of abstraction), a system (not shown, but including the storage 904) may implement the hardware description described by the machine executable code 906. By way of non-limiting example, the processors 902 may include a programmable logic device (e.g., an FPGA or a PLC) and the logic circuitry 908 may be electrically controlled to implement circuitry corresponding to the hardware description into the logic circuitry 908. Also by way of non-limiting example, the logic circuitry 908 may include hard-wired logic manufactured by a manufacturing system (not shown, but including the storage 904) according to the hardware description of the machine executable code 906.

Regardless of whether the machine executable code 906 includes computer-readable instructions or a hardware description, the logic circuitry 908 is adapted to perform the functional elements described by the machine executable code 906 when implementing the functional elements of the machine executable code 906. It is noted that although a hardware description may not directly describe functional elements, a hardware description indirectly describes functional elements that the hardware elements described by the hardware description are capable of performing.

As used in the disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some examples, the different components, modules, engines, and services described in the disclosure may be implemented as objects or processes that execute on the computing system (e.g., as separate threads). While some of the system and methods described in the disclosure are generally described as being implemented in software (stored on and/or executed by general purpose hardware), specific hardware implementations or a combination of software and specific hardware implementations are also possible and contemplated.

As used in the disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A system comprising:
a sensor configured to transmit first radio waves;
a transmitter remote from the sensor and configured to transmit second radio waves, the second radio waves carrying null data;
a receiver remote from the sensor and configured to receive the first radio waves and the second radio waves, the receiver comprising:
a processor; and
a non-transitory computer-readable medium storing instructions thereon, the instructions configured to cause the processor to:
receive a signal waveform comprising a plurality of subcarriers, the signal waveform including the first radio waves and the second radio waves;
determine a signal to noise ratio of each subcarrier of the plurality of subcarriers; and
extract the first radio waves from the signal waveform responsive to the determined signal to noise ratio of each subcarrier of the plurality of subcarriers.

2. The system of claim 1, wherein the first radio waves are obfuscated by the second radio waves when detected by a third-party sensor.

3. The system of claim 1, wherein the second radio waves exhibit a greater energy across a frequency spectrum of the second radio waves than an energy across a frequency spectrum of the first radio waves.

4. The system of claim 1, wherein the receiver comprises a wideband communication receiver.

5. The system of claim 1, further comprising an exciter configured to excite the sensor via an exciter signal.

6. The system of claim 5, wherein the sensor is configured to transmit the first radio waves responsive to the exciter signal.

7. The system of claim 1, wherein the sensor comprises a radio frequency (RF) sensor.

8. The system of claim 1, wherein the first radio waves are based, at least in part, on one or more environmental conditions proximate to the sensor.

9. The system of claim 8, wherein the one or more environmental conditions include one or more of temperature, pressure, and strain.

10. The system of claim 1, wherein the first radio waves are extracted from the signal responsive to detecting signal interference in at least one subcarrier of the plurality of subcarriers.

11. The system of claim 10, wherein the signal interference of the subcarrier is detected responsive to a signal to noise ratio that is relatively greater or smaller than one or more other signal to noise ratios detected at one or more other subcarriers of the plurality of subcarriers.

12. A method comprising:
receiving a signal waveform comprising a plurality of subcarriers, the signal waveform including first radio waves and second radio waves;
determining a signal to noise ratio of each subcarrier of the plurality of subcarriers; and
extracting the first radio waves from the signal waveform responsive to the determined signal to noise ratio of each subcarrier of the plurality of subcarriers.

13. The method of claim 12, wherein extracting the first radio waves from the signal waveform comprises:
determining the signal to noise ratio of each subcarrier of the plurality of subcarriers;
determining that a subcarrier of the plurality of subcarriers is carrying the first radio waves responsive to a signal to noise ratio of the subcarrier exceeding a pre-determined threshold; and
extracting the first radio waves present on the determined subcarrier.

14. The method of claim 12, further comprising transmitting, to a RF sensor, an excitor signal configured to power one or more operations of the RF sensor.

15. The method of claim 14, wherein the RF sensor comprises a plurality of multi-modal sensors.

16. The method of claim 14, further comprising:
receiving, at the RF sensor, one or more measurements of one or more characteristics of an environment responsive to the excitor signal; and
broadcasting, from the RF sensor, the first radio waves comprising the one or more measurements.

17. The method of claim 12, further comprising broadcasting, from a transmitter, the second radio waves wherein the second radio waves include null data.

18. The method of claim 17, wherein the second radio waves exhibit a greater energy across a frequency spectrum of the second radio waves than an energy across a frequency spectrum of the first radio waves.

19. A non-transitory computer-readable medium storing instructions thereon, the instructions configured to cause a processor to:
receive a signal waveform comprising a plurality of subcarriers, the signal waveform including first radio waves and second radio waves;
determine a signal to noise ratio of each subcarrier of the plurality of subcarriers; and
extract the first radio waves from a signal waveform responsive to the determined signal to noise ratio of each subcarrier of the plurality of subcarriers.

20. The non-transitory computer-readable medium of claim 19, further comprising instructions configured to cause the processor to:
determine a signal to noise ratio of each subcarrier of the plurality of subcarriers;
determine that a subcarrier of the plurality of subcarriers is carrying the first radio waves responsive to the signal to noise ratio of the subcarrier exceeding a pre-determined threshold; and
extract the first radio waves present on the determined subcarrier.
